(19) United States
(12) Patent Application Publication
(10) Pub. No.: US 2024/0392156 A1
(43) Pub. Date: Nov. 28, 2024

(54) SURFACE TOLERANT EPOXY COATINGS

(71) Applicant: PPG Industries Ohio, Inc., Cleveland, OH (US)

(72) Inventors: David Ross Curran, Valencia, PA (US); James E. McCarthy, Pittsburgh, PA (US)

(73) Assignee: PPG Industries Ohio, Inc., Cleveland, OH (US)

(21) Appl. No.: 18/692,632

(22) PCT Filed: Sep. 16, 2022
(86) PCT No.: PCT/US2022/076528

§ 371 Date: Mar. 15, 2024

Related U.S. Application Data
(60) Provisional application No. 63/261,301, filed on Sep. 17, 2021.

(51) Int. Cl. C09D 163/00; C09D 5/00

(52) U.S. Cl. CPC C09D 163/00; C09D 5/002

(57) ABSTRACT

Coating compositions may protect substrates from environmental exposure. A coating composition may comprise an epoxy resin component, a polyol, a cardanol-based diluent, and a crosslinking agent. The coating composition may resist chalking and extend the recoat window.

### CROSS-REFERENCE TO RELATED APPLICATIONS

This application claims priority to U.S. Provisional Application No. 63/261,301, filed Sep. 17, 2021, which is incorporated herein by reference in its entirety for all purposes.

### FIELD

Described herein are curable coating compositions for applying to a substrate and methods of treating substrates.

### BACKGROUND

Outdoor structures such as wind turbines, bridges, towers, tanks, pipes, and fleet vehicles such as railcars are constantly exposed to the elements and must be designed to endure temperature extremes, wind shears, precipitation, and other environmental hazards without significant damage or the need for constant maintenance, which may be time-consuming and costly. Likewise, marine structures such as ship hulls and off-shore oil rigs and wind turbines are also exposed to seawater as well as extreme weather and other environmental conditions, making them susceptible to corrosion. More effective treatments and coating systems are continually being sought to meet the specification demands of these industrial structures.

### SUMMARY

The present disclosure is directed to coating compositions. A coating composition may comprise an epoxy resin component, a polyol, a cardanol-based diluent, and a crosslinking agent. The present disclosure is further directed to methods for coating a substrate. A method may comprise applying to at least a portion of the substrate a coating composition described herein. The present disclosure is further directed methods of treating a substrate, where the methods may comprise applying a second coating composition to at least a portion of a substrate, where the substrate comprises a first coating composition according to a coating composition described herein on at least a portion of the substrate.

### DETAILED DESCRIPTION

Provided herein are curable coating compositions and methods that can be applied to substrates to inhibit corrosion. The present disclosure relates to coating compositions that can resist chalking and can extend the recoat window. The coating compositions may demonstrate extended durability and recoat/topcoat properties.

Anti-corrosion coatings may be applied to substrates, such as structures and vehicles, to inhibit corrosion of a substrate exposed to environmental conditions. The substrates may be recoated with an anti-corrosion coating to protect the substrate from corrosion during extended environmental exposure. Conventional anti-corrosive epoxy coatings can weather with environmental exposure, resulting in heavy chalking and degradation of the coating. Substrates with conventional coatings that have weathered can require extensive preparation steps that can be costly and labor intensive to provide suitable surface conditions to enable the substrate to be recoated with an anticorrosion coating or a UV-resistant topcoat. Substrates with conventional coatings can require a tie coat to enable the substrate to be recoated with an anticorrosion coating or a UV-resistant topcoat. The coating compositions described herein can improve performance under severe exterior weathering conditions for extended periods prior to being recoated, without the need for extensive preparation steps and without the need for a tiecoat.

Many conventional epoxy coatings provide an abbreviated recoat window. For example, many conventional epoxy coatings provide a recoat window of 30 days or less. As used herein, “recoat window” is the time between the application of a first anti-corrosion coating to a substrate and the time a second anti-corrosion coating or UV-resistant topcoat is applied to the substrate.

The coating compositions described herein can provide a recoat window of at least 90 days. The coating compositions described herein can provide a recoat window of at least 6 months. The coating compositions described herein can provide a recoat window of one year or more. The coating compositions described herein can provide a recoat window of at least 16 months. The coating compositions described herein can provide a recoat window of at least 20 months. An extended recoat window may be desirable. An extended recoat window can provide flexibility for supply chain logistics, scheduled maintenance, and extended construction schedules. Delays from weather, transport, and other influences can cause logistical unpredictability for products having protective coatings. In some cases, logistical delays can exceed the recoat window for conventional epoxy coatings and result in additional preparation steps. In some such cases, substrates can be exposed to extreme temperature changes, wind shear, precipitation, and UV irradiation due to logistical delays or other reasons. These conditions can negatively impact recoat properties of a substrate and degrade an anti-corrosion coating. A weathered substrate having a conventional coating may need to be abraded, blasted, or otherwise undergo some degree of surface preparation to enable the substrate to be recoated. A weathered substrate having a conventional coating may need to have an aged coating composition removed to enable the substrate to be recoated.

Described herein are coating compositions that may comprise an epoxy resin component, a polyol, a cardanol-based diluent, and a crosslinking agent. In some cases, a coating composition may comprise 11 to 18 weight percent epoxy resin component, up to 5 weight percent polyol, up to 6 weight percent cardanol-based diluent, and 5 to 22 weight percent crosslinking agent, based on total solid weight of the composition. The coating composition may further comprise a pigment and/or an extender. The coating composition may further comprise a rheology modifier, a dispersing agent, a pigment, an extender, an accelerator, a solvent, or combinations thereof.

The coating composition described herein may comprise a polyol in an amount of up to 15 wt. % (e.g., from 2 to 15%, 3 to 15%, from 2 to 5%, from 3 to 10%, from 3 to 8%, from 3 to 5%, from 4 to 4.5%, from 4 to 5%, up to 5%, up to 8%, or up to 10%,). The composition may include 20%, 2.2%, 2.40% 2.60% 2.8%, 3%, 3.20% 3.4%, 3.6%, 3.8%, 40%, 4.20% 4.4%, 4.6%, 4.8%, 5%, 5.2%, 5.4%, 5.6%, 5.8%, 6%, 6.2%, 6.4%, 6.6%, 6.8%, 7.0%, 7.2% 7.4%, 7.6%, 7.8%, 8.0%, 8.2%, 8.4%, 8.6%, 8.8%, 9.0%, 9.2%, 9.4%, 9.6%, 9.8%, 10.00%, 10.20%, 10.40%, 10.60%, 10.80%, 11.00%, 11.20%, 11.40%, 11.60%, 11.80%, 12.00%, 12.2% 12.40%, 12.60%, 12.80%, 13.00%, 13.20%, 13.40%, 13.60%, 13.80%, 14.00%, 14.20%, 14.40%, 14.6%, 14.8%, or 15.0% polyol. All percentages of polyol are expressed in wt. % based on the total solid weight of the composition. The polyol may be an acrylic polyol. The polyol may be a polyester polyol.

The polyol may have a hydroxyl value of from 48 to 150 mg KOH, such as 100 to 150 mg KOH. For example, the acrylic polyol may have a hydroxyl value of 48 mg KOH, 55 mg KOH, 60 mg KOH, 65 mg KOH, 70 mg KOH, 75 mg KOH, 80 mg KOH, 85 mg KOH, 90 mg KOH, 95 mg KOH, 100 mg KOH, 105 mg KOH, 110 mg KOH, 115 mg KOH, 120 mg KOH, 125 mg KOH, 130 mg KOH, 135 mg KOH, 140 mg KOH, 145 mg KOH, or 150 mg KOH. As used herein, “hydroxyl value” is a measure of the content of free hydroxyl groups in a chemical substance. The hydroxyl value is the number of milligrams of potassium hydroxide (KOH) required to neutralize the acetic acid taken up on acetylation of one gram of a chemical substance that contains free hydroxyl groups. The polyol may have a glass transition temperature of from 9 to 50° C., for example 17 to 26° C. For example, the polyol may have a glass transition temperature of 9° C., 10° C., 11° C., 12° C., 13° C., 14° C., 15° C., 16° C., 17° C., 18° C., 19° C., 20° C., 21° C., 22° C., 23° C., 24° C., 25° C., 26° C., 27° C., 28° C., 29° C., 30° C., 35° C., 40° C., 45° C., or 50° C.

The coating composition described herein may comprise a cardanol-based diluent in an amount of up to 20 wt. % (e.g., from 2 to 20%, from 3.5 to 20%, from 4 to 18%, from 5 to 17%, from 2 to 8%, 3 to 6%, from 4 to 5.5%, from 5.5 to 6%, up to 6%, up to 9%, or up to 10%). The composition may include 2%, 2.2%, 2.4%, 2.6%, 2.8%, 3%, 3.2%, 3.4%, 3.6%, 3.8%, 4%, 4.2%, 4.4%, 4.6%, 4.8%, 5%, 5.2%, 5.4%, 5.6%, 5.8%, 6%, 6.2%, 6.4%, 6.6%, 6.8%, 7.0%, 7.2%, 7.4%, 7.6%, 7.8%, 8.0%, 8.2%, 8.4%, 8.6%, 8.8%, 9.0%, 9.2%, 9.4%, 9.6%, 9.80%, 10.0%, 10.20%, 10.40%, 10.60%, 10.80%, 11.0%, 11.20%, 11.40%, 11.60%, 11.80% 12.0%, 12.2%, 12.4%, 12.6%, 12.8%, 13.0%, 13.2%, 13.4%, 13.6%, 13.8%, 14.0%14.2%, 14.4%, 14.6%, 14.8%, 15.0%, 15.2%, 15.4%, 15.6%, 15.8%, 16.0%, 16.2%, 16.4%, 16.6%, 16.8%, 17.0%, 17.2%, 17.4%, 17.6%, 17.8%, 18.0%, 18.2%, 18.4%, 18.6%, 18.8%, 19.0%, 19.2%, 19.4%, 19.6%, 19.8%, or 20.0% cardanol-based diluent. All percentages of cardanol-based diluent are expressed in wt. % based on the total solid weight of the composition. The cardanol-based diluent may have a hydroxyl value of 170 mg KOH. The cardanol-based diluent may include a terminal hydroxyl group. The cardanol-based diluent may be a phenolic lipid. The cardanol-based diluent may be 2-Hydroxyethyl Ether of Cashew Nutshell Liquid. The cardanol-based diluent may include varying lengths of chains or alkyl groups as shown in the structures I, II, and III.

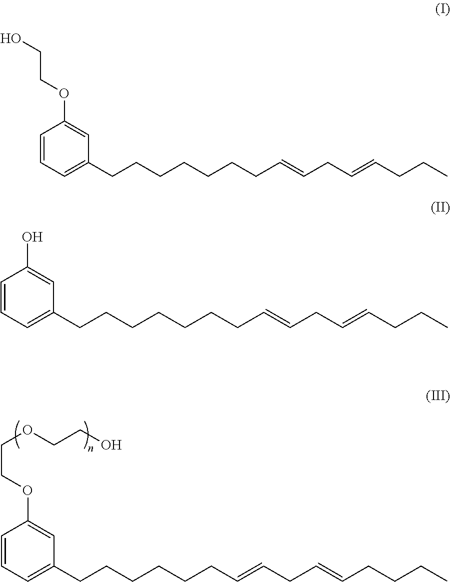

The coating composition described herein may comprise an epoxy resin component in an amount of from 11 wt. % to 20 wt. % (e.g., from 11 to 18%, from 11 to 15%, from 12 to 17%, from 14 to 16%, or from 11 to 18%). The composition may include 11%, 12%, 13%, 14%, 15%, 16%, 17%, 18%, 19%, or 20% epoxy resin component. All percentages of epoxy resin component are expressed in wt. % based on the total solid weight of the composition. The epoxy resin component may have an epoxy equivalent weight of from 170 grams to 575 grams, for example 184 to 500 grams. The epoxy resin component may comprise a liquid epoxy resin and a solid epoxy resin. The liquid epoxy resin may have an epoxy equivalent weight of 170 grams to 205 grams. The solid epoxy resin may have an epoxy equivalent weight of 400 grams to 575 grams. The epoxy resin component may have a ratio of solid epoxy resin to liquid epoxy resin (S/L) of from 1.0 to 2.1. The ratio of solid epoxy resin to liquid epoxy resin (S/L) may be 1.0, 1.1, 1.2, 1.3, 1.4, 1.5, 1.6, 1.7, 1.8, 1.9, 2.0, or 2.1. Epoxy resins can include examples such as bisphenol-A diglycidyl ether epoxy resins or aliphatic or cycloaliphatic epoxy resins. Examples of liquid epoxy resins can include Epikote 828 (from Westlake), D.E.R. 331 (from Dow), Araldite GY 250 (Hunstman). Examples of solid epoxy resins can include EPON 1001 (from Westlake), D.E.R. 671 (from Dow), Araldite GT 7071 (Hunstman).

The coating composition described herein may comprise a crosslinking agent in an amount of from 3 wt. % to 22 wt. % (e.g., from 3 to 8%, from 7 to 15%, or from 10 to 20%). The composition may include 3%, 4%, 5%, 6%, 7%, 8%, 9%, 10%, 11%, 12%, 13%, 14%, 15%, 16%, 17%, 18%, 19%, 20%, 21%, or 22% crosslinking agent. All percentages of crosslinking agent are expressed in wt. % based on the total solid weight of the composition. The crosslinking agent may have an amine hydrogen equivalent weight of from 65 grams to 360 grams, for example 130 grams to 360 grams. The crosslinking agent may comprise a polyamide or a polyamidoamine. The crosslinking agent may comprise an adduct of the specified crosslinking agents (e.g., a polyamide adduct or a polyamidoamine adduct). In some cases, an example can include an amine functional adduct or an epoxy polyamide adduct. Crosslinking agents can include standard reactive polyamide or polyamide/epoxy adduct, polyfunctional reactive amidoamine, or tertiary amine Lewis base catalyst.

The coating composition may further comprise a pigment in an amount up to 15 wt. % (e.g., from 1 to 5%, from 2 to 8%, or from 5 to 15%). The composition may include about 1%, 20% 30% 4% 5%, 6%, 7%, 8%, 90%, 100%, 11%, 120%, 13%, 140%, or 15% pigment. All percentages of pigment are expressed in wt. % based on the total solid weight of the composition. The composition may be free of pigment. The pigment may comprise titanium dioxide, carbon black, or other pigments compatible with epoxy coatings known to one skilled in the art.

The coating composition may further comprise an extender in an amount up to 55 wt. % (e.g., from 5 to 15%, from 10 to 25%, or from 25 to 30%). The composition may include 1%20%, 40%, 60%, 8%, 10%, 120%, 140%, 160%, 18%, 200%, 220%, 240%, 260%, 28%, 300%, 32%, 34%, 36%, 38%, 40%, 42%, 44%, 46%, 48%, 50%, 52%, 54% or 55% extender. All percentages of extender are expressed in wt. % based on the total solid weight of the composition. The extender may comprise a mineral such as calcium metasilicate, silicone dioxide, titanium dioxide, nypheline syenite, barium sulfate, or other extenders compatible with epoxy coatings known to one skilled in the art.

The coating composition may further comprise additives in an amount up to 10 wt. % (e.g., from 1 to 3%, from 2 to 8%, or from 3 to 5%). The composition may include 1%, 2%, 3%, 4%, 5%, 6%, 7%, 8%, 9%, or 10% additives. All percentages of additives are expressed in wt. % based on the total solid weight of the composition. The additives may comprise a rheology modifier, a dispersing agent, an accelerator, or combinations thereof. The rheology modifier may comprise an organic wax dispersion and/or a polyamide wax. The dispersing agent may comprise a salt of polyamine amides and acidic polyesters. The rheology modifier may comprise a castor oil derivative. The castor oil derivative may be organically modified. The accelerator may comprise a tertiary amine. The accelerator may be free of organometallic compounds. The additives may increase viscosity of the composition and aid with particle suspension and sag control.

The coating composition may further comprise a solvent in an amount of up to 20 wt. % (e.g., from 1 to 3%, from 2 to 8%, or from 3 to 5%). The composition may include 1%, 2%, 30% 40% 5%, 6%, 7%, 8%, 90%, 100%, 11%, 120%, 13%, 140%, 150%, 160%, 170%, 180%, 19%, or 20% solvent. All percentages of solvent are expressed in wt. % based on the total solid weight of the composition. The composition may be free of solvent. The solvent may comprise methyl isobutyl ketone or other organic solvents known to those skilled in the art.

The coating composition may be free of an isocyanate component. The coating composition may be free of an epoxy novolac resin or a modified epoxy novolac resin.

In some cases, a coating composition may comprise 11 to 20 weight percent epoxy resin component, up to 15 weight percent polyol, up to 20 weight percent cardanol-based diluent, and 3 to 22 weight percent crosslinking agent, based on total solid weight of the composition. In some cases, a coating composition may comprise 11 to 20 weight percent epoxy resin component, 2 to 15 weight percent polyol, 2 to 20 weight percent cardanol-based diluent, and 3 to 22 weight percent crosslinking agent, based on total solid weight of the composition. In some cases, a coating composition may comprise 11 to 18 weight percent epoxy resin component, 2 to 5 weight percent polyol, 2 to 6 weight percent cardanol-based diluent, and 3 to 22 weight percent crosslinking agent, based on total solid weight of the composition. In some cases, a coating composition may comprise 11 to 18 weight percent epoxy resin component, 2 to 5 weight percent polyol, 2 to 6 weight percent cardanol-based diluent, and 3 to 22 weight percent crosslinking agent, based on total solid weight of the composition. In some cases, a coating composition may comprise 11 to 18 weight percent epoxy resin component, up to 5 weight percent polyol, up to 6 weight percent cardanol-based diluent, and 5 to 22 weight percent crosslinking agent, based on total solid weight of the composition. In some cases, a coating composition may comprise 11 to 18 weight percent epoxy resin component, 2 to 5 weight percent polyol, 2 to 6 weight percent cardanol-based diluent, and 3 to 22 weight percent crosslinking agent, based on total solid weight of the composition. In some cases, a coating composition may comprise 15 to 35 weight percent epoxy resin component, up to 5 weight percent polyol, up to 6 weight percent cardanol-based diluent, and 5 to 22 weight percent crosslinking agent, based on total solid weight of the composition. The coating composition may further comprise a pigment and/or an extender. The coating composition may further comprise a rheology modifier, a dispersing agent, a pigment, an extender, an accelerator, a solvent, or combinations thereof. In some cases, a coating composition may comprise 11 to 18 weight percent epoxy resin component, up to 5 weight percent polyol, up to 6 weight percent cardanol-based diluent, 5 to 22 weight percent crosslinking agent, up to 15 weight percent pigment, up to 40 weight percent extender, and up to 12 weight percent solvent based on total solid weight of the composition. In some cases, a coating composition may comprise 11 to 20 weight percent epoxy resin component, 2 to 15 weight percent polyol, 2 to 20 weight percent cardanol-based diluent, 3 to 22 weight percent crosslinking agent, up to 15 weight percent pigment, up to 55 weight percent extender, and up to 20 weight percent solvent based on total solid weight of the composition.

In some cases, a coating composition may comprise 11 to 18 weight percent epoxy resin component, 2 to 5 weight percent polyol, 4 to 10 weight percent cardanol-based diluent, 3 to 8 weight percent crosslinking agent, up to 15 weight percent pigment, up to 55 weight percent extender, and up to 20 weight percent solvent based on total solid weight of the composition.

The coating composition may have a prolonged period of time of chalk resistance when exposed to environmental conditions such as extreme temperature changes, wind shear, precipitation, and UV irradiation. The coating composition may resist moderate to heavy chalking for at least 90 days as measured by ASTM D4214.

Also disclosed herein are methods for treating a substrate. A method of treating a substrate may comprise applying a second coating composition to at least a portion of a substrate, where the substrate comprises a first coating composition according to the coating composition described herein on at least a portion of the substrate. The second coating may be the same as the first coating or different than the first coating. The second coating may be an epoxy coating compatible with the first coating. The second coating may be a urethane coating.

In some cases, the method can further comprise preparing at least a portion of the substrate prior to applying the second coating composition. Any debris and/or loose chalking may be removed from the substrate prior to applying the second coating composition. The substrate may be rinsed with water. The first coating layer may resist chalking and need less preparation than conventional applications for recoat. For example, the method does not include abrading the substrate, blasting the substrate, or otherwise removing the first coating composition to prepare the substrate for the second coating composition. As described herein, the first coating composition can resist chalking and provide for a recoat window of one year or more. Preparing the substrate and applying the second coating composition can be performed at least 3 months after the first coating composition was applied to the substrate. Preparing the substrate and applying the second coating composition can be performed at least 6 months after the first coating composition was applied to the substrate. Preparing the substrate and applying the second coating composition can be performed up to 12 months after the first coating composition was applied to the substrate. Preparing the substrate and applying the second coating composition can be performed up to 20 months after the first coating composition was applied to the substrate. In some cases, preparing the substrate and applying the second coating composition can be performed more than 12 months after the first coating composition was applied to the substrate. Applying the second coating composition may comprise pneumatic spraying, airless spraying, brushing, rolling, or by other means known to those skilled in the art. The method may not include heating or curing the second coating composition.

The method may further comprise exposing the substrate comprising the first coating composition to outdoor environmental conditions prior to applying the second coating composition. Outdoor environmental conditions can include extreme temperature changes, wind shear, precipitation, and UV irradiation.

Optionally, the method may further comprise applying a top coating layer on at least a portion of the second coating composition. The top coating layer may comprise a polyurethane or a polysiloxane. The top coating layer may comprise a pigment.

A method for coating a substrate may comprise applying to at least a portion of the substrate the coating composition described herein.

A substrate may comprise the coating composition described herein. The substrate for the coating composition described herein can comprise iron, steel, steel alloys, galvanized metals, or concrete. Suitable substrates for use in the methods described herein include metal substrates such as ferrous metals, aluminum, aluminum alloys, and other metal and alloy substrates. The ferrous metal substrates used in the practice of the present disclosure may include iron, steel, and alloys thereof. Non-limiting examples of useful steel materials include hot and cold rolled steel, galvanized (zinc coated) steel, electrogalvanized steel, stainless steel, pickled steel, and combinations thereof. Use of titanium as a substrate may be excluded. Combinations or composites of ferrous and non-ferrous metals can also be used.

The substrate can comprise a vehicle, a structure, or an industrial protective structure, such as an electrical box enclosure, transformer housing, motor control enclosure, railcar container, tunnel, bridge, oil or gas industry component, such as, platforms, pipes, tanks, vessels, and their supports, marine components, automotive body parts, aerospace components, pipelines, storage tanks, wind turbine components, and general purpose steel specimen. An article may comprise a substrate comprising the coating composition described herein.

“Structure” as used herein refers to a building, bridge, oil rig, oil platform, water tower, power line tower, support structures, wind turbines, walls, piers, docks, levees, dams, shipping containers, trailers, and any metal structure that is exposed to a corrosive environment. “Vehicle” refers to in its broadest sense all types of vehicles, such as but not limited to cars, trucks, buses, tractors, harvesters, heavy duty equipment, vans, golf carts, motorcycles, bicycles, railcars, airplanes, helicopters, boats of all sizes and the like.

As used herein, unless otherwise expressly specified, all numbers such as those expressing values, ranges, amounts or percentages may be read as if prefaced by the word “about”, even if the term does not expressly appear. Any numerical range recited herein is intended to include all subranges subsumed therein. When ranges are given, any endpoints of those ranges and/or numbers within those ranges can be combined with the scope of the present disclosure. Notwithstanding that the numerical ranges and parameters setting forth the broad scope of the present disclosure are approximations, numerical values set forth in the specific examples are reported as precisely as possible. Any numerical value, however, inherently contains certain errors necessarily resulting from the standard variation found in their respective testing measurements. When ranges are given, any endpoints of those ranges and/or numbers within those ranges can be combined within the scope of the present disclosure. Including and like terms means “including but not limited to”. The word “comprising” and forms of the word “comprising” as used in this description and in the claims does not limit the disclosure claimed to exclude any variants or additions.

As used herein, the terms “on”, “applied on/over”, mean formed or provided on but not necessarily in contact with the surface. Each of the characteristics and examples described above and below, and combinations thereof, may be said to be encompassed by the present disclosure.

As used herein, the meaning of “a,” “an,” and “the” includes singular and plural references unless the context clearly dictates otherwise.

As used herein, the terms “disclosure,” “the disclosure,” “this disclosure” and “the present disclosure” are intended to refer broadly to all of the subject matter of this patent application and the claims below. Statements containing these terms should be understood not to limit the subject matter described herein or to limit the meaning or scope of the patent claims below. The terms “comprising,” “having,” “including,” and “containing” are to be construed as open-ended terms (i.e., meaning “including, but not limited to”) unless otherwise noted.

Although the present disclosure has been described in terms of “comprising”, “consisting essentially of” or “consisting of” are also within the scope of the present disclosure. In this context, “consisting essentially of” means that any additional components will not materially affect the viscosity or other properties of the composition.

The following working examples are intended to further describe the present disclosure. It is understood that the disclosure described in this specification is not necessarily limited to the examples described in this section. Components that are mentioned elsewhere in the specification as suitable alternative materials for use in the disclosure, but which are not demonstrated in the working examples below, are expected to provide results comparable to their demonstrated counterparts.

### Examples

Notwithstanding that the numerical ranges and parameters setting forth the broad scope of the disclosure are approximations, numerical values set forth in the specific examples are reported as precisely as possible. Any numerical value, however, inherently contains certain errors necessarily resulting from the standard variation found in their respective testing measurements.

The following process was performed to prepare all examples for evaluation.

Steel panels were cleaned and blasted before the coating composition was applied. Steel panels were prepared for application by cutting (sheared) followed by commercial degreasing to remove oils and other contaminants. Panels where then blasted with G-50 abrasive to a profile of 2.0-2.5 mils and SP5 cleanliness. Following steel substrate preparation and prior to coating application, the panels were solvent cleaned with xylene to remove any accumulated dust and debris.

A 2K Polyamide Cured Epoxy Coating as described herein was applied to the panel using an FLG-670 or FLG-678 Gravity Feed Spray Gun. The coatings were thoroughly mixed prior to application, following required induction times, and thinned 5% with xylene as appropriate to achieve good application properties.

Following application, all panels were allowed to air dry at ambient conditions, generally 68° F.-72° F. and 45-50% RH. Open edges were sealed with general corrosion resistant epoxy once the panels were thoroughly dry. Panels were then exposed to natural outdoor subtropical climates in South Florida per ASTM D1014 (2009) (45 Degrees Equatorial Facing Exposure). This region typically receives between 275 and 380 MJ/m² of solar radiation annually.

Following determined exposure intervals, the panels were evaluated for chalking development via modified ASTM D 4214 Method A (2007, reapproved 2015). Method A was followed except for the wool requirement. Chalking was evaluated using a bare finger. Panels were then washed under tap water to gently remove loose chalking and debris from exposures.

A second coating layer was applied to exposed epoxy primer. An epoxy coating or a polyurethane topcoat was applied using an FLG-670 or FLG-678 Gravity Feed Spray Gun. Coatings were thoroughly mixed prior to application, following required induction times, and thinned 5% with Xylene (for epoxies) or 5% N-Butyl Acetate (for polyurethanes) as appropriate to achieve good application properties.

Following full cure, typically 5-7 days, adhesion of the coating system was evaluated via ASTM D-3359 (2008) Method A.

Two coating formulations (Ex. 1 and Ex. 2) were prepared according to the compositions described herein in paragraph [0021] for evaluation on test panels. Ex. 1 was a white semi-gloss film-forming composition prepared using an acrylic polyol, cardanol diluent, polyamide adduct and liquid and solid epoxy resins that may be applied to a metal substrate as a primer or as a mid-coat within a coating system. Ex. 1 demonstrated the preparation of multi-package curable film-forming compositions, suitable for use as coating kits. Ex. 2 was a clear semi-gloss film-forming composition prepared using an acrylic polyol, cardanol diluent, polyamide adduct and liquid and solid epoxy resins that may be applied to a metal substrate as a primer or as a mid-coat within a coating system. Ex. 2 demonstrated the preparation of multi-package curable film-forming compositions, suitable for use as coating kits.

Typical properties of curable film-forming compositions of Ex. 1 and Ex. 2 as well as a Comparative Example utilized for performance screening on test panels are provided in Tables 1-3. The Comparative Example was a conventional epoxy composition that is commercially available.

TABLE 1

| | Ex. 1 | Ex. 2 | Comp. Ex. |
|---|---|---|---|
| General Properties | White | Neutral | White |
| Mix ratio, by volume | 1:1 | 1:1 | 3:1 |
| Solids by volume | 72% | 72% | 80% |
| VOC (lb/gal) | <2.0 | < 2.0 | 1.9 |
| Sprayable Pot-life | 4 Hours | 4 Hours | 1 Hour |
| Air Dry Time (Dry to Handle) | 7 Hours | 7 Hour | 2 Hours |

Test panels were coated with Ex. 1, Ex. 2, or the Comp. Ex., shipped to Florida for evaluation after exposure under the Florida Weathering Method per ASTM standards. 18 total panels were initially prepared. Nine panels were designated to be recoated with epoxy after exposure, and nine panels were designated to be topcoated with urethane after exposure. Two panels of the total set of panels were returned for testing at pre-determined exposure intervals. After being returned, recoated/topcoated and properties evaluated, the test panel were not re-exposed.

The curable film-forming compositions of Ex. 1 and Ex. 2 demonstrated improved chalking resistance compared to conventional epoxies as shown in Table 2. The curable film-forming compositions of Ex. 1 demonstrated improved recoat adhesion compared to conventional epoxies as shown in Table 3.

TABLE 2

| Properties - Chalking Resistance | | Ex. 1 | Ex. 2 | Comp. Ex. |
|---|---|---|---|---|
| ASTM D-4214 | | White | Neutral | White |
| 30 Days | ASTM | 10 - None | 10 - None | 10 - None |
| 60 Days | D1014 | 8 - Minor | 8 - Minor | 8 - Minor |
| 90 Days | | 8 - Minor | 8 - Minor | 4 - Heavy |
| 240 Days | | 6 - Moderate | 6 - Moderate | 2 - Heavy |
| 360 Days | | 4 - Heavy | 4 - Heavy | 2 - Heavy |
| 487 Days | | 4 - Heavy | 4 - Heavy | 2 - Heavy |
| 608 Days | | 4 - Heavy | 4 - Heavy | 2 - Heavy |

TABLE 3

| PROPERTIES - Weathered Adhesion | | Ex. 1 | Comp. Ex. |
|---|---|---|---|
| | Exposure | Recoat Adhesion | |
| | Interval | Following Exposure - | |
| Recoat System | ASTM D1014 | ASTM D-3359 Method A | |
| Recoat with Epoxy (Self) | 30 Days | 5A | NA |
| | 60 Days | 4A | 0 |
| | 90 Days | 4A | 0 |
| | 120 Days | 4A | 0 |
| | 360 Days | 5A | NA |
| | 487 Days | 5A | NA |
| | 608 Days | 5A | NA |
| Recoat with Urethane | 30 Days | 5A | NA |
| | 60 Days | 5A | 0 |
| | 90 Days | 5A | 0 |
| | 120 Days | 5A | 0 |
| | 360 Days | 5A | NA |
| | 487 Days | 5A | NA |
| | 608 Days | 5A | NA |

Curable film-forming compositions of Ex. 1 and Ex. 2 demonstrated improved recoat performance compared to conventional epoxies.

TABLE 4

| | Ex. 1 | Ex. 2 | Comp. Ex. |
|---|---|---|---|
| PROPERTIES - General | White | Neutral | White |
| Sag Resistance ASTM D-4400 | 20+ mils | 20+ mils | 10+ |
| (1999 reapproved 2007) | | | |
| Elongation ¼ Inch Mandrel | Pass | Pass | NA |
| ASTM 522 Method B | | | |
| (93A reapproved 2001) | | | |
| Hardness | 50-55 | 50-55 | NA |
| Koenig Oscillations ASTM D-4366 | | | |
| (1995) | | | |

Whereas various examples of the disclosure have been described in fulfillment of the various objectives of the disclosure, it should be recognized that these examples are merely illustrative of the principles of the present disclosure. Numerous modifications and adaptations thereof will be readily apparent to those skilled in the art without departing from the spirit and scope of the present disclosure as defined in the following claims.

1. A coating composition comprising:
an epoxy resin component;
a polyol;
a cardanol-based diluent; and
a crosslinking agent.

2. The coating composition of claim 1, wherein the polyol comprises up to 15 weight percent based on total solid weight of the composition.

3. The coating composition of claim 1, wherein the polyol has an hydroxyl value of from 100 to 150 mg KOH.

4. The coating composition of claim 1, wherein the polyol has a glass transition temperature of from 17 to 26° C.

5. The coating composition of claim 1, wherein the cardanol-based diluent comprises up to 20 weight percent based on total solid weight of the composition.

6. The coating composition of claim 1, wherein the epoxy resin component comprises a liquid epoxy resin and a solid epoxy resin, and has an epoxy equivalent weight of from 184 to 500 grams.

7. The coating composition of claim 1, wherein the epoxy resin component comprises from 11 to 20 weight percent based on total solid weight of the composition.

8. (canceled)

9. The coating composition of claim 1, wherein the crosslinking agent comprises from 3 to 22 weight percent based on total solid weight of the composition.

10. The coating composition of claim 1, further comprising a pigment and/or an extender.

11. The coating composition of claim 1, further comprising a rheology modifier, a dispersing agent, and/or an accelerator.

12. The coating composition of claim 1, wherein the coating composition comprises 11 to 20 weight percent epoxy resin component, up to 15 weight percent polyol, up to 20 weight percent cardanol-based diluent, and 3 to 22 weight percent crosslinking agent, based on total solid weight of the composition.

13. The coating composition of claim 1, wherein the coating composition resists chalking for at least 90 days as measured by ASTM D4214.

14. A substrate comprising the coating composition of claim 1.

15. An article comprising the substrate of claim 14.

16. A method for coating a substrate comprising applying to at least a portion of the substrate the coating composition according to claim 1.

17. (canceled)

18. A method of treating a substrate comprising:
applying a second coating composition to at least a portion of a substrate,
wherein the substrate comprises a first coating composition according to the coating composition of claim 1 on at least a portion of the substrate.

19. The method of claim 18, wherein the second coating composition comprises a composition according to claim 1.

20. (canceled)

21. The method of claim 18, further comprising preparing at least a portion of the substrate prior to applying the second coating composition.

22. (canceled)

23. The method of claim 21, wherein preparing the substrate does not include abrading the substrate, blasting the substrate, or removing the first coating composition.

24. The method of claim 21, wherein preparing the substrate and applying the second coating composition are performed up to 12 months after the first coating composition was applied to the substrate.

25. (canceled)

26. (canceled)
